(19) United States
(12) Patent Application Publication
(10) Pub. No.: US 2014/0284996 A1
(43) Pub. Date: Sep. 25, 2014

(54) IDLER ASSEMBLY FOR A TRACK ROLLER FRAME

(71) Applicant: Caterpillar Inc., Peoria, IL (US)

(72) Inventor: Jamel Necib, Rives sur Fure (FR)

(21) Appl. No.: 14/299,339

(22) Filed: Jun. 9, 2014

(51) Int. Cl. B62D 55/30

(52) U.S. Cl. CPC B62D 55/30
USPC 305/145

(57) ABSTRACT

The present disclosure describes an idler assembly for a track roller frame. The idler assembly may provide travel with reduced vibrations in a track type machine. The idler assembly may comprise a hydraulic cylinder having a piston rod extendable along a linear actuation path; an idler wheel movable along a linear tensioning path inclined relative the linear actuation path; and a coupling mechanism coupling the piston rod to the idler wheel wherein the movement of the piston rod along the linear actuation path actuates the idler wheel to move along the linear tensioning path.

### TECHNICAL FIELD

This disclosure relates to track type machines, in particular to track roller frames for track type machines and more particularly to idler assemblies for track roller frames.

### BACKGROUND

Track type machines may be commonly used in applications where traction is critical or low ground pressure is important. Current track-driven machines use an endless track and chain assembly to provide load distribution and propulsion within a track system. Examples of track type machines may be dozers, excavators, and skid-steer loaders.

Track type machines may consist of a track roller frame, a plurality of rollers, one or more idler wheels, a driving wheel or sprocket, and a track chain. The track chain may have track shoes that are connected to links to form an endless loop which encircles the track roller frame, the idler wheel(s) and the driving wheel. The track chain may have grousers that protrude from track shoes of the track chain. Idler assemblies may be provided to vary tension in the track chain. The idler assembly may comprise an actuator that causes the idler wheel, that is in contact with the track chain, to move so as to vary tension in the track chain.

Track type machines may have an undercarriage that supports an internal combustion engine, and left and right track roller frames that transfer power from the engine to a ground surface. The left and right track roller frames may be rigidly mounted at one end to the frame and may be free to pivot in a vertical direction about the mounting location.

The track roller frames may be connected to the frame by a pivot shaft. Each of the track roller frames may include a front idler wheel and a rear idler wheel and a roller around which the track chain may be positioned. The track roller frames may have a rugged construction that exhibit a high degree of structural integrity in order to support the track type machine.

The present disclosure is directed, at least in part, to improving or overcoming one or more aspects of the prior art system.

### BRIEF SUMMARY OF THE INVENTION

In a first aspect, the present disclosure describes an idler assembly for a track roller frame. The idler assembly may comprise a hydraulic cylinder having a piston rod extendable along a linear actuation path; an idler wheel movable along a linear tensioning path inclined relative the linear actuation path; and a coupling mechanism coupling the piston rod to the idler wheel wherein the movement of the piston rod along the linear actuation path actuates the idler wheel to move along the linear tensioning path.

In a second aspect, the present disclosure describes a track roller frame. The track roller frame may comprise a housing; a track chain; a hydraulic cylinder mounted to the housing, the hydraulic cylinder having a piston rod extendable along a linear actuation path; an idler wheel movably positioned in the housing, the idler wheel being movable along a liner tensioning path inclined relative to the linear actuation path; and a coupling mechanism coupling the piston rod to the idler wheel wherein the movement of the piston rod along the actuation path actuates the idler wheel to move along the tensioning path for varying the tension in the track chain.

In a third aspect, the present disclosure describes a track type machine. The track type machine may comprise at least one track roller frame having a housing and a track chain; a hydraulic cylinder mounted to the housing, the hydraulic cylinder having a piston rod extendable along a linear actuation path; an idler wheel movably positioned in the housing, the idler wheel being movable along a liner tensioning path inclined relative to the linear actuation path; and a coupling mechanism coupling the piston rod to the idler wheel wherein the movement of the piston rod along the actuation path actuates the idler wheel to move along the tensioning path for varying the tension in the track chain.

### BRIEF DESCRIPTION OF THE DRAWINGS

The foregoing and other features and advantages of the present disclosure will be more fully understood from the following description of various embodiments, when read together with the accompanying drawings, in which:

FIG. 1 is an isometric view of a first embodiment of an idler assembly according to the present disclosure;

FIG. 2 is an isometric view of a first embodiment of an idler assembly according to the present disclosure;

FIG. 3 is an isometric view of a second embodiment of an idler assembly according to the present disclosure;

FIG. 4 is a schematic drawing of an idler assembly with an idler wheel moved from a first position to a second position by a hydraulic cylinder;

FIG. 5 is a side view of a track roller frame incorporating the idler assembly of FIG. 1;

FIG. 6 is a side view of a portion of a track chain with grousers; and

FIG. 7 is an isometric view of a track roller frame incorporated in a track type machine.

### DETAILED DESCRIPTION

This disclosure generally relates to an idler assembly for a track roller frame. The idler assembly may enable a smooth ride and balance to be provided in a track type machine having the track roller frame with the idler assembly.

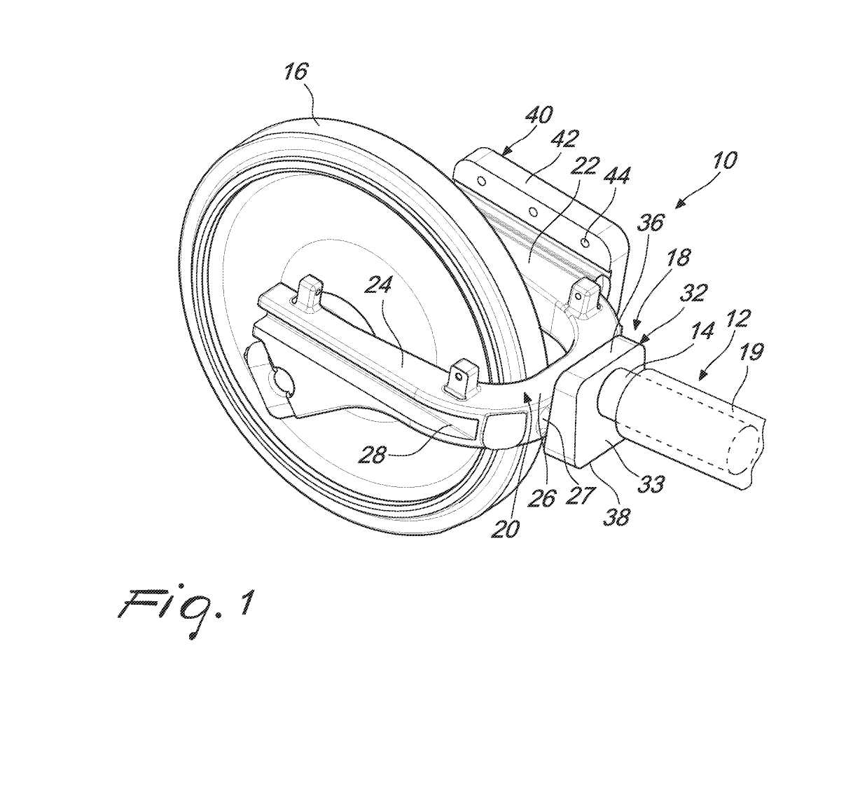

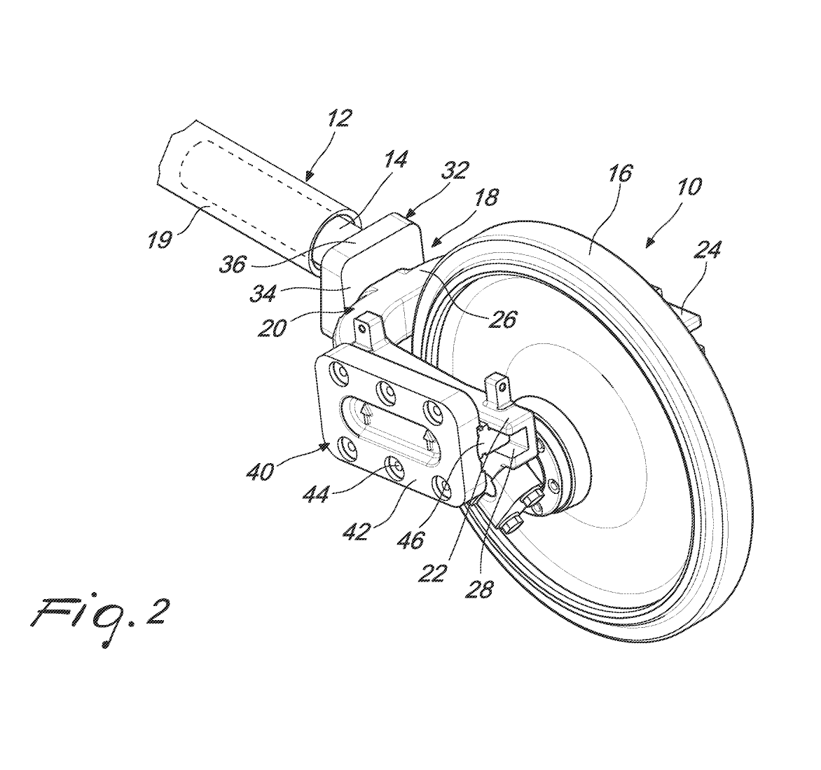

FIGS. 1 and 2 illustrate the idler assembly 10. The idler assembly 10 may comprise a hydraulic cylinder 12 having a piston rod 14, an idler wheel 16 and a coupling mechanism 18.

The hydraulic cylinder 12 may include a cylinder barrel 19 and a piston (not shown) that may be connected to the piston rod 14. Piston rod 14 may be hydraulically actuated to move within the cylinder barrel 19. Piston rod 14 may move within the cylinder barrel 19 in a linear motion. The movement of the piston rod 14 may correspond to a central axis of cylinder barrel 19.

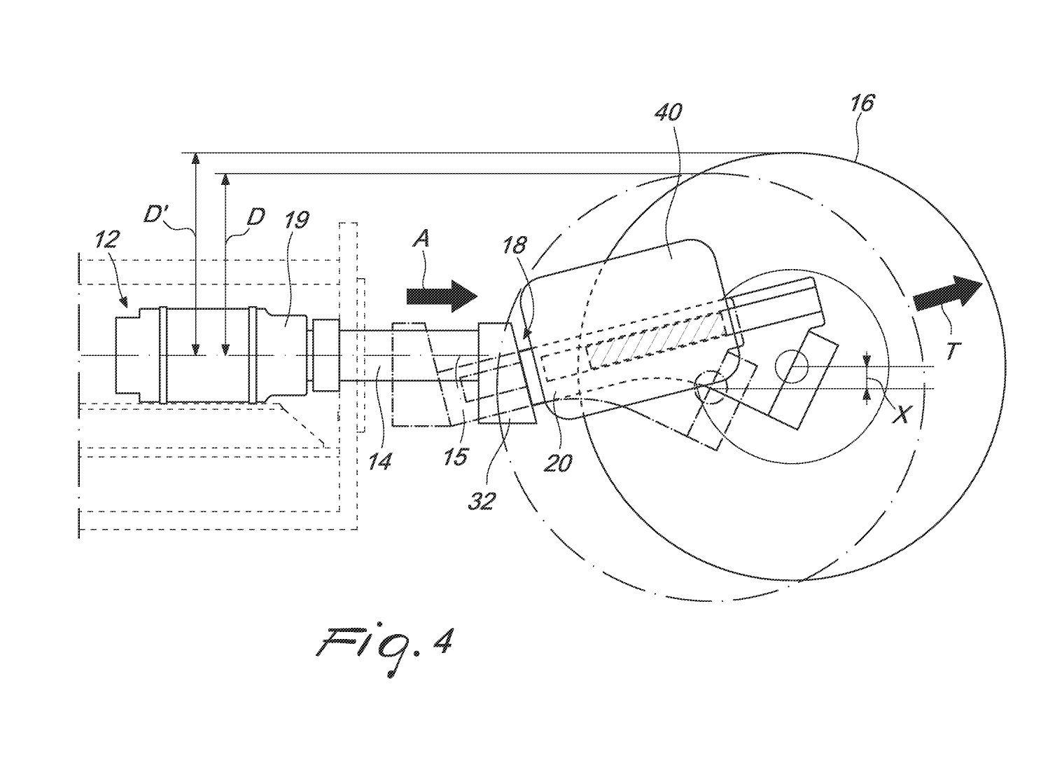

FIG. 4 schematically illustrates the movement of the piston rod 14, idler wheel 16 and the coupling mechanism 18. The piston rod 14 may be hydraulically actuated to move along an actuation path A. Piston rod 14 may extend and retract along the actuation path A. The actuation path A may be linear. The actuation path A may axially extend from the hydraulic cylinder 12. Actuation path A may be parallel to the central axis of the cylinder barrel 19.

The hydraulic cylinder 12 may be connected to a hydraulic tensioning circuit (not shown) to provide fluid pressure for extension and retraction of the piston rod 14. The hydraulic tensioning circuit may be independent of the track type machine fluid circuit. In an embodiment, the hydraulic fluid circuit may be connected to the track type machine fluid circuit.

The operation of the idler assembly 10 may be effected by an operator controlling the hydraulic tensioning circuit through an operator input device. In an embodiment, the operation of the idler assembly 10 may be effected through a control system having a computing device. The control system may be configured to control the hydraulic tensioning circuit.

The idler wheel 16 may move along a predefined tensioning path T. The tensioning path T may be inclined relative to the actuation path A. The tensioning path T may be inclined relative to the linear actuation path A. The tensioning path T and the actuation path A may both lie on the same plane. The tensioning path T and the actuation path A may aligned vertically in the plane. The tensioning path T may be linear. Tensioning path T may extend linearly away from the actuation path A. Tensioning path T may extend linearly away from the hydraulic cylinder 12. Idler wheel 16 may be aligned with the tensioning path T. Idler wheel 16 may be aligned with the plane through which both the tensioning path T and the actuation path A lie.

In an embodiment, the tensioning path T may intersect with the actuation path A. The piston rod 14 may extend through a point at an end of the tensioning path T. The piston rod 14 may extend through a point at a start end of the tensioning path T where the idler wheel 16 may be closest to the actuation path A.

The coupling mechanism 18 may couple the piston rod 14 to the idler wheel 16. The coupling mechanism 18 may couple the piston rod 14 to the idler wheel 16 such that the movement of the piston rod 14 along the linear actuation path A may actuate the idler wheel 16 to move along the tensioning path T.

The extension and refraction of the piston rod 14 may effect corresponding movement of the idler wheel 16. The idler wheel 16 may be moved from a first position to a second position. The movement of the idler wheel 16 from the first position to the second position may be a forward movement relative to the hydraulic cylinder 12. The movement of the idler wheel 16 from the second position to the first position may be a rearward movement relative to the hydraulic cylinder 12. The second position may be elevated relative to the first position. The second position may have a higher relative vertical height compared to the first position. The movement of the idler wheel 16 from the first position to the second position the tensioning path T may be elevated relative to the actuation path A.

The idler wheel 16 may be in a static state at the first position such that the idler wheel 16 may not be able to move without input of force from the piston rod 14. At the second position the idler wheel 16 may have a tendency to move back to the first position. At the second position, the idler wheel 16 may remain in a static state when being maintained by a force provided by the piston rod 14.

The coupling mechanism 18 may transmit a force of the piston rod 14 as it extends from the hydraulic cylinder 12 to the idler wheel 16. The idler wheel 16 may be moved along the tensioning path T with the force provided from the piston rod 14. As the piston rod 14 retracts into the hydraulic cylinder 12 the force may not be provided to the idler wheel 16. The idler wheel 16 may retreat from the second position to the first position in the absence of the force provided from the piston rod 14. In an embodiment, the force provided by the piston rod 14 may be a pushing force.

The movement of the idler wheel 16 along the tensioning path T may vary the relative vertical distance between the idler wheel 16 and the actuation path A. Idler wheel 16 may have a relative vertical distance from the actuation path A at the first position. Idler wheel 16 may have a relative vertical distance from the actuation path A at the second position.

The movement of the idler wheel 16 along the tensioning path T may vary the relative vertical distance between the idler wheel 16 and longitudinal axis 15 of the piston rod 14. Idler wheel 16 may have a relative vertical distance D from longitudinal axis 15 at the first position. Idler wheel 16 may have a relative vertical distance D′ from the longitudinal axis 15 at the second position. The magnitude of vertical distance D may vary relative to the magnitude of vertical distance D′ as the idler wheel moves between the first position and the second position. The magnitude of vertical distance may increase as the idler wheel 16 moves from the first position to the second position.

The movement of the idler wheel 16 along the tensioning path T may cause a change in the position thereof between the first position and the second position. The idler wheel 16 may move by a vertical distance X when moved between the first position and the second position along the tensioning path T. With reference to FIGS. 1 and 2, the coupling mechanism 18 may comprise a yoke element 20. The idler wheel 16 may be rotatably connected to the yoke element 20. The yoke element 20 may transmit the moving force from the piston rod 14 to the idler wheel 16. Yoke element 20 may be formed as a single fabricated or cast component.

Yoke element 20 may have a first arm 22 and a second arm 24. First arm 22 may be spaced apart from the second arm 24. First arm 22 may be spaced apart from the second arm 24 in the transverse direction with respect to the tensioning path T. The idler wheel 16 may be rotatably supported by the first and second arms 22, 24. The idler wheel 16 may be rotatably supported between the first and second arms 22, 24. First and second arms 22, 24 may extend in a direction that is substantially parallel to the tensioning path T. First and second arms 22, 24 may extend in a direction that is substantially parallel to the longitudinal axis 15 of the piston rod 14.

Yoke element 20 may have a base 26 from which the first and second arms 22, 24 may extend. The base 26 may be formed as a c-shaped structure. Respective terminal portions of base 26 may be connected to the first and second arms 22, 24. Base 26 may extend in a direction that is substantially perpendicular to the tensioning path T. Base 26 may extend in a direction that is substantially perpendicular to the longitudinal axis 15 of the piston rod 14. Base 26 may be provided with an engagement portion 27. Engagement portion 27 may be provided on the side opposite to the side having the first and second arms 22, 24. Engagement portion 27 may extend in a direction opposite to the direction of extension of the first and second arms 22, 24.

With reference to FIG. 4, yoke element 20 may be movable relative to the hydraulic cylinder 12. Yoke element 20 may be movable relative to the hydraulic cylinder 12. Yoke element 20 may be movable along a direction that is parallel to the tensioning path T.

Movement of the yoke element 20 along the direction parallel to the tensioning path T may vary the relative vertical distance between the yoke element 20 and the actuation path A. Movement of the yoke element 20 along the direction parallel to the tensioning path T may vary the relative vertical distance between the yoke element 20 and the hydraulic cylinder 12. Movement of the yoke element 20 along the direction parallel to the tensioning path T may vary the relative vertical distance between the yoke element 20 and the longitudinal axis 15 of the piston rod 14.

With reference to FIG. 1, yoke element 20 may have at least one slot 28 provided on the first arm 22 or the second arm 24. Slot 28 may be linear. Slot 28 may axially extend along the first or second arm 22, 24. Slot 28 may be substantially parallel to the tensioning path T. Slot 28 may define the tensioning path T of the idler wheel 16. Yoke element 20 may be movable in the direction of the slot 28.

Yoke element 20 may have slots 28 provided on the first arm 22 and the second arm 24. Slots 28 may be mutually aligned and mutually parallel. Slots 28 may axially extend along the outer surfaces of the first and second arms 22, 24. Slots 28 may extend from the free ends of the first or second arms 22, 24 to the ends connected to the base 26.

With reference to FIG. 2, in an embodiment, yoke element 20 may have at least one yoke flange 30 provided on the first arm 22 or the second arm 24. Yoke flange 30 may be linear. Yoke flange 30 may axially extend along the first or second arm 22, 24. Yoke flange 30 may be substantially parallel to the tensioning path T. Yoke element 20 may be movable in the direction of the yoke flange 30. In an embodiment, yoke flange 30 may have a cross section that is substantially a square.

Yoke element 20 may have yoke flanges 30 provided on the first arm 22 and the second arm 24. Yoke flanges 30 may be mutually aligned and mutually parallel. Yoke flanges 30 may axially extend along the outer surfaces of the first and second arms 22, 24. Yoke flanges 30 may extend from the free ends of the first or second arms 22, 24 to the ends connected to the base 26.

The movement of the piston rod 14 may effect a movement of the yoke element 20 along a direction that is parallel to the tensioning path T. In an embodiment, the movement of the piston rod 14 may effect a movement of the yoke element 20 along the tensioning path T.

The extension and refraction of the piston rod 14 may effect corresponding movement of the yoke element 20. The yoke element 20 may be moved from a first position to a second position. The movement of the yoke element 20 from the first position to the second position may be a forward movement relative to the hydraulic cylinder 12. The movement of the yoke element 20 from the second position to the first position may be a rearward movement relative to the hydraulic cylinder 12.

The yoke element 20 may be in a static state at the first position such that the yoke element 20 may not be able to move without input of force from the piston rod 14. At the second position the yoke element 20 may have a tendency to move back to the first position. At the second position, the yoke element 20 may remain in a static state when being maintained by a force provided by the piston rod 14.

A force may be transmitted by the piston rod 14 as it extends from the hydraulic cylinder 12 towards the yoke element 20. The yoke element 20 may be moved along a direction that is parallel to the tensioning path T with the force provided from the piston rod 14. In an embodiment, the yoke element 20 may be moved along the tensioning path T with the force provided from the piston rod 14.

As the piston rod 14 retracts into the hydraulic cylinder 12 the force may not be provided to the yoke element 20. The yoke element 20 may retreat from the second position to the first position in the absence of the force provided from the piston rod 14. In an embodiment, the force provided by the piston rod 14 may be a pushing force.

With reference to FIG. 1, the coupling mechanism 18 may further comprise a link element 32. The link element 32 may be connected to the piston rod 14. Link element 32 may be connected to the piston rod 14 at an end opposite the end connected to the piston (not shown). Link element 32 may have a connection surface 33 that is mechanically connected to the piston rod first or second. The connection surface 33 may be perpendicular to the actuation path A.

Link element 32 may be coupled to the yoke element 20. Yoke element 20 may be movably coupled to the link element 32. Yoke element 20 may be movable relative to the link element 32. Yoke element 20 may be in movable abutting engagement with the link element 32. In an embodiment, the engagement portion 27 of the yoke element 20 may be movably coupled to the link element 32. Engagement portion 27 may be in movable abutting engagement to the link element 32.

With reference to FIG. 2, link element 32 may have a contact surface 34 that is available for movable contact with the yoke element 20. In an embodiment, the contact surface 34 may be available for contact with the engagement portion 27. Contact surface 34 may be located opposite to the connection surface 33 connected to the piston rod 14. Contact surface 34 may face the base 26 of the yoke element 20.

In an embodiment, contact surface 34 may be level and the yoke element 20 may slidably abut the contact surface 34. The contact surface 34 may be relatively smooth for the sliding engagement of the yoke element 20 and the contact surface 34. In a further embodiment, engagement portion 27 may be in sliding engagement with the contact surface 34.

Contact surface 34 may be inclined relative to the connection surface 33. Contact surface 34 may be inclined relative to the actuation path A. Contact surface 34 may have an upward inclination relative to the actuation path A. Contact surface 34 may be inclined relative to the longitudinal axis L of the piston rod 14. Contact surface 34 may have an upward inclination relative to the longitudinal axis 15 of the piston rod 14. Contact surface 34 may be inclined relative to the vertical plane comprising the actuation path A and the tensioning path T.

The link element 32 may have the contact surface 34 being inclined relative to the side connected to the piston rod 14. Link element 32 may have a first side 36 and a second side 38. First side 36 may be opposite to the second side 38. First side may be narrower relative to the second side 38. Link element 32 may be orientated such that the narrower first side 36 faces the direction of inclination of the tensioning path T. Link element 32 may be orientated such that the narrower first side 36 faces an elevated direction relative to the actuation path A. Link element 32 may be orientated such that the narrower first side 36 faces an upward direction. The link element 32 may be slanted away from the yoke element 20.

With reference to FIG. 4, the movement of the piston rod 14 may effect a corresponding movement of the link element 32. The link element 32 may move along the actuation path A. The link element 32 may move linearly along the actuation path A. The contact surface 34 may have a movement along the actuation path A. The contact surface 34 may have a linear translational movement along the actuation path A. The angle of inclination of the contact surface 34 relative to the actuation path A may remain constant as the link element 32 moves along the actuation path A.

The movement of link element 32 along the actuation path A may effect corresponding movement of the yoke element 20. The extension and retraction of the piston rod 14 may be transmitted to the yoke element 20 through the link element 32. The yoke element 20 may be moved along a direction that is parallel to the tensioning path T by the piston rod 14 through the link element 32. In an embodiment, the yoke element 20 may be moved along the tensioning path T by the piston rod 14 through the link element 32.

Yoke element 20 may slide on the link element 32 between the first side 36 and the second side 38 as the piston rod 14 extends or retracts. Yoke element 20 may move towards the first side 36 from the second side 38 as the piston rod 14 extends from the hydraulic cylinder 12. Yoke element 20 may move towards the second side 38 from the first side 36 as the piston rod 14 retracts from the hydraulic cylinder 12.

The inclination of the contact surface 34 may have an effect of providing a resultant force that moves the yoke element 20 along a direction that is parallel to the tensioning path T. In an embodiment, the inclination of the contact surface 34 may have an effect of providing a resultant force that moves the yoke element 20 along the tensioning path T. Yoke element 20 may move between the rearward first position and the forward second position as an effect of the inclined contact surface 34 moving along the actuation path A.

With reference to FIGS. 1 and 2, the idler assembly 10 may further comprise a guide element 40. The guide element 40 may be configured to guide the idler wheel 16 along the tensioning path T. Guide element 40 may have a panel portion 42 with through holes 44. Holes 44 may be provided in two rows on either side of the panel portion 42. Bolts (not shown) may be positioned through the holes 44 for coupling of the guide element 40. The yoke element 20 may be engaged with the guide element 40.

With reference to FIGS. 1 and 2, in a first embodiment, the guide element 40 may have a flange 46. Flange 46 may be centrally positioned on the panel portion 42. Flange 46 may extend longitudinally along the panel portion 42. Flange 46 may be linear. Flange 46 may be substantially parallel to the tensioning path T. Flange 46 may have a cross section that is substantially a square.

Flange 46 may engage into slot 28 in the yoke element 20. Flange 46 may movably engage in slot 28. Flange 46 may slidably move in slot 28. Yoke element 20 may be movable in the direction of the flange 46.

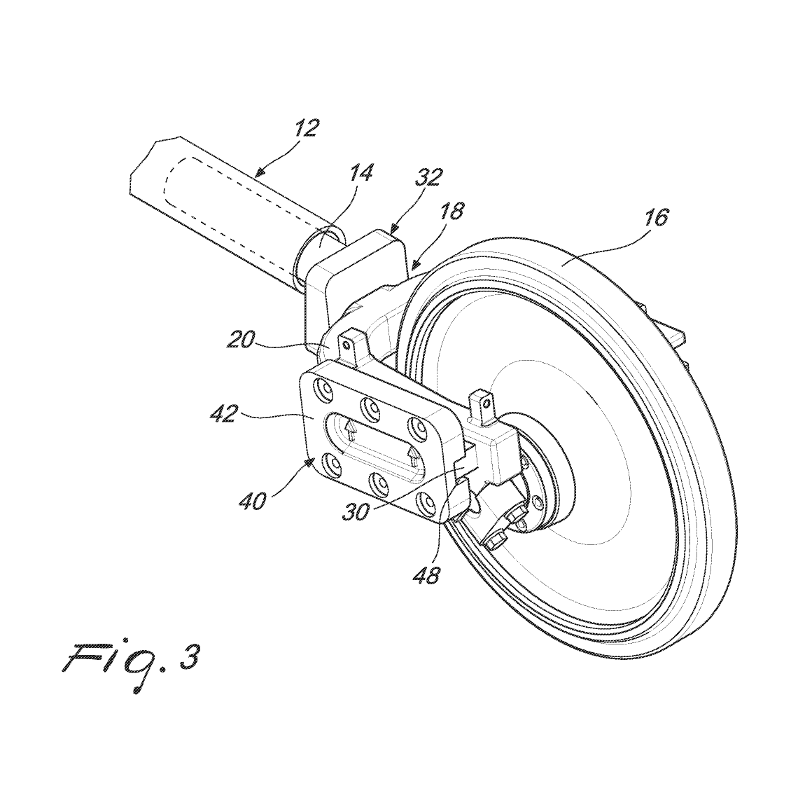

With reference to FIG. 3, in a second embodiment, the guide element 40 may have a slot 48. Slot 48 may be centrally positioned on the panel portion 42. Slot 48 may extend longitudinally along the panel portion 42. Slot 48 may be linear. Slot 48 may be substantially parallel to the tensioning path T. In an embodiment, the slot 48 may be defined the tensioning path T. Slot 48 may have a cross section that is substantially a square.

Yoke element may have a flange 30 that may engage into slot 48 in the guide element 40. Flange 30 may movably engage in slot 48. Flange 30 may slidably move in slot 48. Yoke element 20 may be movable in the direction of the slot 48.

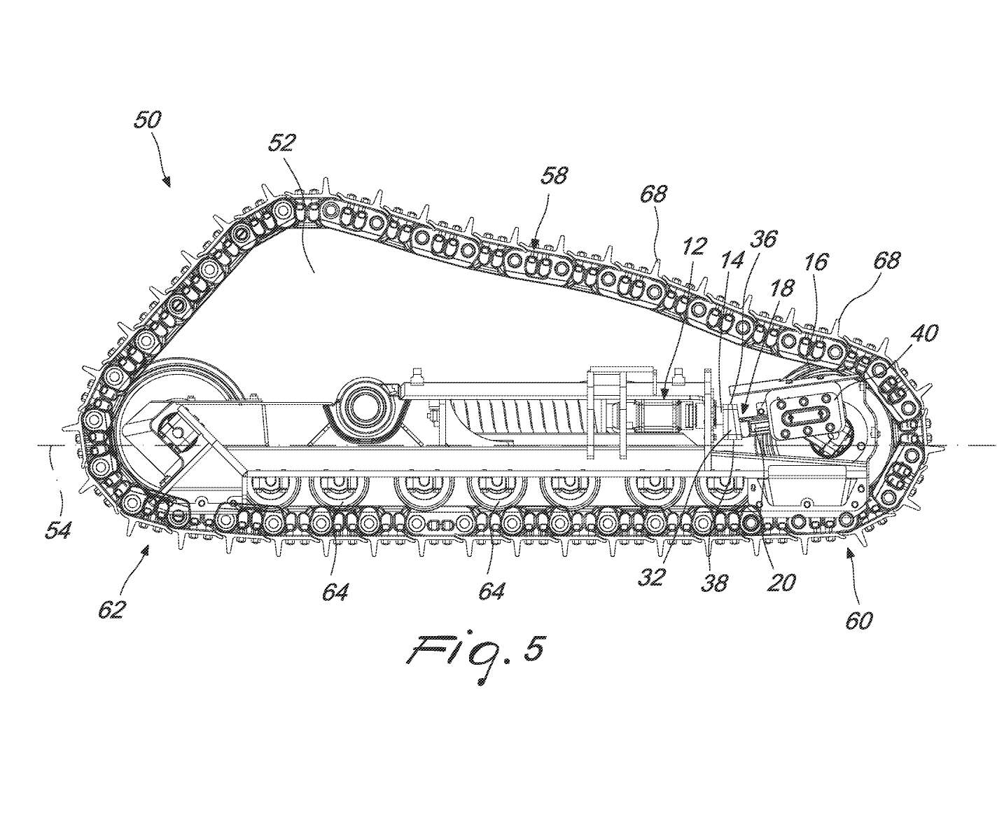

FIG. 5 illustrates a track roller frame 50. The track roller frame 50 may comprise a housing 52. Housing 52 may form a substantially hollow support structure that at least partially houses the components of the track roller frame 50. Housing 52 may have a longitudinal axis 54. The housing 52 may be coupled to a main frame (not shown) by a pivot shaft 56. Housing 52 may be a single fabricated or cast component.

The track roller frame 50 may further comprise a track chain 58. The track chain 58 may include a plurality of interconnected track links and a plurality of track shoes secured to the track links.

The track roller frame 50 may further comprise the idler assembly 10 as hereinabove described. The hydraulic cylinder 12 may be mounted to the housing 52. Hydraulic cylinder 12 may serve to move the idler wheel 16 into engagement with the track chain 58.

The hydraulic cylinder 12 may have a piston rod 14 that is extendable and retractable along the linear actuation path A. In an embodiment, the actuation path A may be parallel to the longitudinal axis 54 of the housing 52. The piston rod 14 may be movable relative to the housing 52. The piston rod 14 may act to move the idler wheel 16 so to maintain engagement of the idler wheel 16 with the track chain 58.

The idler wheel 16 may be movably positioned in the housing 52. The idler wheel 16 may be movable along the linear tensioning path T that is inclined relative to the linear actuation path A. The tensioning path T may be may be inclined at an angle of 5 degrees to 60 degrees relative to the actuation path A. The tensioning path T may be may be inclined at an angle of 10 degrees to 45 degrees relative to the actuation path A. The tensioning path T may be may be inclined at an angle of 15 degrees to 25 degrees relative to the actuation path A.

The linear tensioning path T may be inclined relative to the longitudinal axis 54 of the housing 52. The tensioning path T may be may be inclined at an angle of 5 degrees to 60 degrees relative to the longitudinal axis 54 of the housing 52. The tensioning path T may be may be inclined at an angle of 10 degrees to 45 degrees relative to the longitudinal axis 54 of the housing 52. The tensioning path T may be may be inclined at an angle of 10 degrees to 25 degrees relative to the longitudinal axis 54 of the housing 52.

In an embodiment, the idler wheel 16 may be a front idler wheel positioned at the fore region 60 of the housing 52. In an alternative embodiment, the idler wheel 16 may be a rear idler wheel positioned at the aft region 62 of the housing 52.

In an embodiment, actuation path A may be a forward axial direction relative to the fore region 60 of housing 52. Tensioning path T may be a forward inclined axial direction relative to the fore region 60 of housing 52. Tensioning path T may be inclined in an upward direction relative to the housing 52.

The coupling mechanism 18 may couple the piston rod 14 to the idler wheel 16 wherein the movement of the piston rod 14 along the liner actuation path A may actuate the idler wheel 16 to move along the linear tensioning path T for varying the tension in the track chain 58. Movement of the idler wheel 16 along the tensioning path T may vary the relative vertical distance between the idler wheel 16 and the longitudinal axis 54 of the housing 52.

Coupling mechanism 18 may cause the idler wheel 16 to move along the tensioning path T toward the track chain 58 so as to increase tension therein when the piston rod 14 extends along the actuation path A. Tension in the track chain 58 may increase with the idler wheel 16 being moved away from the cylinder barrel 19 of the hydraulic cylinder 12. Coupling mechanism 18 may be movable relative to the housing 52. The link element 32 and the yoke element 20 of the coupling mechanism may be movable relative to the housing 52.

Coupling mechanism 18 may cause the idler wheel 16 to move along the tensioning path T away from the track chain 58 so as to decrease tension therein when the piston rod 14 retracts along the actuation path A. Tension in the track chain 58 may decrease with the idler wheel 16 being moved toward away from the cylinder barrel 19 of the hydraulic cylinder 12.

Slots 28 of the yoke element 20 may be substantially inclined relative to the longitudinal axis 54 of the housing element 52. The link element 32 may be oriented such that the first side 36 faces an upward direction and the second side 38 faces a downward direction relative to the housing 52.

The guide element 40 may be mounted to the housing 52. The guide element 40 may be configured to guide the idler wheel 16 along the linear tensioning path T. Guide element 40 may couple the yoke element 20 to the housing 52. Guide element 40 may determine the position of the yoke element 20 relative to the housing 52. The guide element 40 may couple yoke element 20 to the housing 52 such that the yoke element 20 is movable relative to the housing 52. In an embodiment, the slot 48 of the guide element 40 may be substantially inclined relative to the longitudinal axis 54 of the housing element 52.

The housing 52 may further comprise a plurality of guide rollers 64 and a drive sprocket (not shown). The housing may further comprise a second idler wheel 66. Track chain 58 may encircle the drive sprocket, the idler wheel 16 and the guide rollers 64. The guide rollers 64 may guide the track links as the track chain 58 is driven by the drive sprocket. The track chain 58 may further comprise grousers 68. Grousers 68 may extend from the track chain for engaging the ground.

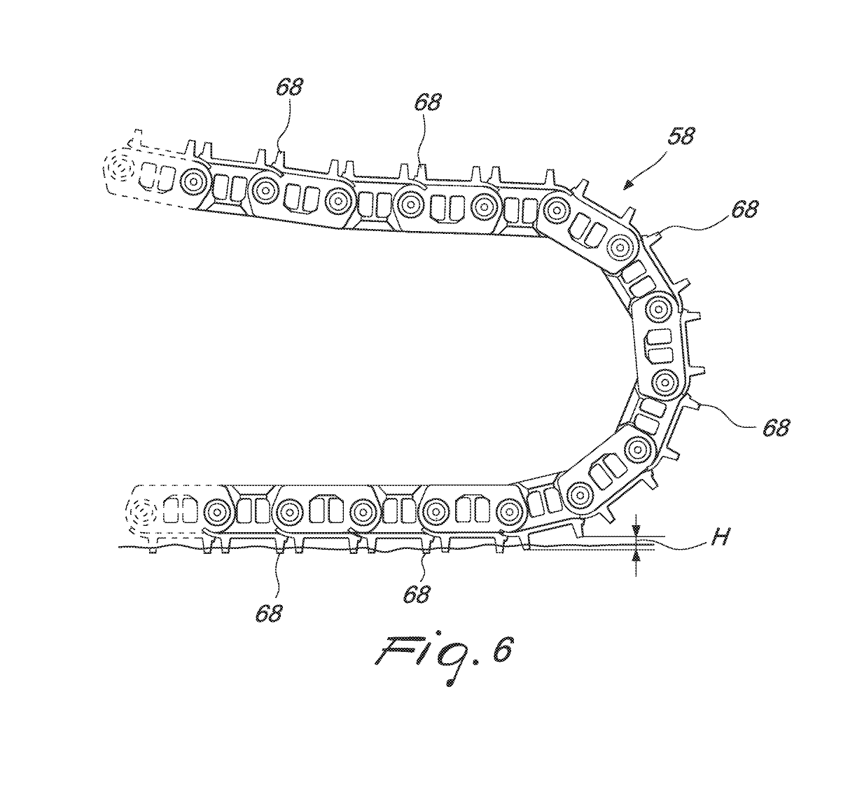

FIG. 6 illustrates a track chain 58 in contact with the ground. A grouser height H may be defined as the maximum distance between the bottom of a first grouser of a first track shoe that is in contact with the ground and the bottom of a second grouser of a second, adjacent track shoe that is not yet in contact with the ground. The first track shoe may be the track shoe that is in contact with the ground and which is nearest to the fore region 60 of the housing 52.

A positive grouser height H may be defined as the bottom of a first grouser of a first track shoe that is in contact with the ground being relatively higher to the bottom of a second grouser of a second, adjacent track shoe that is not yet in contact with the ground. A negative grouser height H may be defined as the bottom of a first grouser of a first track shoe that is in contact with the ground being relatively lower to the bottom of a second grouser of a second, adjacent track shoe that is not yet in contact with the ground.

Increasing the tension in the track chain 58 may increase the grouser height H. Increasing the tension in the track chain 58 as the idler wheel moves from a first position towards a second position may increase the grouser height H. Decreasing the tension in the track chain 58 may decrease the grouser height H. Decreasing the tension in the track chain 58 as the idler wheel moves from a second position towards a first position may decrease the grouser height H.

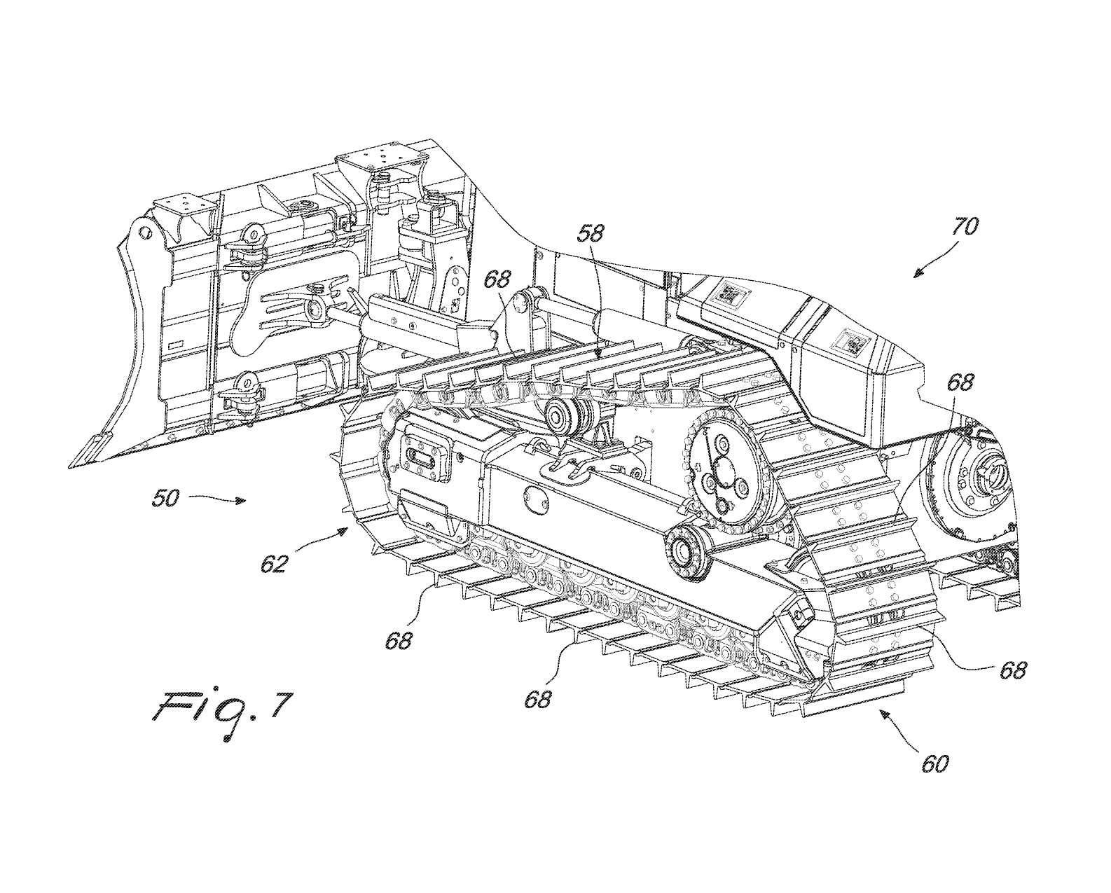

FIG. 7 illustrates a partial track type machine 70 comprising the track roller frame 50 having the housing 52 and the track chain 58. The track type machine 70 may further comprise the hydraulic cylinder 12 mounted to the housing 52, the hydraulic cylinder 12 having a piston rod 14 extendable along the linear actuation path A; an idler wheel 16 movably positioned in the housing 52, the idler wheel 16 being movable along the liner tensioning path T inclined relative to the linear actuation path A; and a coupling mechanism 18 coupling the piston rod 14 to the idler wheel 16 wherein the movement of the piston rod 14 along the linear actuation path A actuates the idler wheel 16 to move along the linear tensioning path T for varying the tension in the track chain 58.

The track type machine 70 may be a track type tractor or a machine that includes a drive track undercarriage mounted around a track roller frame. For example, a variety of track type machines, including but not limited to excavators, loaders and landfill equipment, as well as others, are within the scope of the present disclosure.

The idler assembly 10 may be located at the forward or front portion of the track type machine 70. Idler assembly 10 may extend longitudinally from the track roller frame 50. The idler wheel 16 may be the front idler wheel of the track type machine 70 with respect of the forward travelling direction thereof.

The skilled person would appreciate that foregoing embodiments may be modified or combined to obtain an apparatus or device that is configured to translate the linear extension of the hydraulic cylinder 12 to a movement of the idler wheel 16 along the tensioning path T.

The skilled person would appreciate that foregoing embodiments may be modified or combined to obtain the idler assembly 10, a track roller frame 50 and a track type machine 70 of the present disclosure.

### INDUSTRIAL APPLICABILITY

This disclosure describes an idler assembly 10 for a track roller frame 50. The track roller frame 50 may be included in a track type machine 70. The idler assembly 10 may enable the track type machine 70 to travel smoothly. A track type machine 70 may be subject to unwanted vibrations while travelling which may occur if the idler wheel 16 is biased towards the track chain 58. The vibrations may arise in the track chain 58.

In the present idler assembly 10 the idler wheel 16 may travel along a tensioning path T that is inclined relative to the actuation path A of the hydraulic cylinder 12. The hydraulic cylinder 12 may actuate the idler wheel 16 to move along tensioning path T. The idler wheel 16 may be actuated by the movement of the piston rod 14 along an actuation path A. The axial movement of the piston rod 14 may cause the idler wheel 16 to move in a linear angular direction with respect to the axial movement of the piston rod 14. The idler wheel 16 may move in an upwardly inclined direction. The movement of the idler wheel 16 against the track chain 58 may increase the tension thereof as the idler wheel 16 moves away from contact with the ground.

In addition, the movement of the idler wheel 16 may increase the grouser height H which may affect ride and balance of the track type machine 70 while travelling. A minimum grouser height H may be required to provide the track type machine 70 with a relatively smooth ride and balance while travelling. Over time the grouser height H may decrease and even take a negative value which may tend to cause the track type machine 70 to be subject to vibrations while travelling. The increase in grouser height H may reduce the occurrence of vibrations. The increase in grouser height H from a negative value to a positive value may reduce the occurrence of vibrations. The increase in grouser height H from a low positive value to a higher positive value may reduce the occurrence of vibrations.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

Where technical features mentioned in any claim are followed by reference signs, the reference signs have been included for the sole purpose of increasing the intelligibility of the claims and accordingly, neither the reference signs nor their absence have any limiting effect on the technical features as described above or on the scope of any claim elements.

One skilled in the art will realise the disclosure may be embodied in other specific forms without departing from the disclosure or essential characteristics thereof. The foregoing embodiments are therefore to be considered in all respects illustrative rather than limiting of the disclosure described herein. Scope of the invention is thus indicated by the appended claims, rather than the foregoing description, and all changes that come within the meaning and range of equivalence of the claims are therefore intended to be embraced therein.

1. An idler assembly for a track roller frame , the idler assembly comprising:
a hydraulic cylinder having a piston rod extendable along a linear actuation path;
an idler wheel movable along a linear tensioning path inclined relative the linear actuation path; and
a coupling mechanism coupling the piston rod to the idler wheel wherein the movement of the piston rod along the linear actuation path actuates the idler wheel to move along the linear tensioning path.

2. The idler assembly of claim 1 wherein the movement of the idler wheel along the linear tensioning path varies the relative vertical distance between the idler wheel and the actuation path.

3. The idler assembly of claim 1 wherein the hydraulic cylinder has a retracted configuration wherein the idler wheel is at a first position along the tensioning path, and an extended configuration wherein the idler wheel is at a second position along the tensioning path, the second position being elevated with respect to the first position

4. The idler assembly of claim 1 wherein the coupling mechanism comprises a yoke element having spaced apart first and second arms, the first and second arms rotatably supporting the idler wheel.

5. The idler assembly of claim 4 further comprising a link element connected to the piston rod, the link element being coupled to the yoke element.

6. The idler assembly of claim 5 wherein the yoke element (20) is movably coupled to the link element.

7. The idler assembly of claim 6 wherein the link element has a contact surface inclined relative to the actuation path and wherein the yoke element movably abuts the contact surface.

8. The idler assembly of claim 6 wherein the link element has a level contact surface inclined relative to the actuation path and wherein the yoke element slidably abuts the contact surface.

9. The idler assembly of claim 8 wherein the link element has an connection surface opposite the contact surface, the connection surface being perpendicular to the actuation path (A) and inclined relative to the contact surface (34).

10. The idler assembly of claim 1 further comprising a guide element configured to guide the idler wheel along the linear tensioning path.

11. The idler assembly of claim 10 further comprising a yoke element configured to rotatably support the idler wheel wherein the yoke element is configured to engage the guide element.

12. The idler assembly of claim 10 wherein the guide element has a slot for engagement of a flange extending from the yoke element.

13. The idler assembly of claim 12 wherein the slot defines the linear tensioning path.

14. The idler assembly of claim 1 wherein the tensioning path elevates in the direction from the first position to the second position relative to the linear actuation path.

15. A track roller frame for a track type machine comprising:
a housing;
a track chain;
a hydraulic cylinder mounted to the housing, the hydraulic cylinder having a piston rod extendable along a linear actuation path;
an idler wheel movably positioned in the housing and configured to at least partly support the track chain, the idler wheel being movable along a linear tensioning path inclined relative to the linear actuation path; and
a coupling mechanism coupling the piston rod to the idler wheel wherein movement of the piston rod along the actuation path actuates the idler wheel to move along the tensioning path for varying the tension in the track chain.

16. The track roller frame of claim 15 further comprising a guide element (40) mounted to the housing, the guide element being configured to guide the idler wheel along the linear tensioning path.

17. The track roller frame of claim 15, wherein the housing comprises a longitudinal axis that is parallel to the linear actuation path and wherein the track chain follows an elongate circuit substantially along the longitudinal axis, the idler wheel positioned towards an extremity of the elongate circuit.

18. The track roller frame of claim 15 wherein the tension in the track chain increases with the idler wheel being moved away from a cylinder barrel of the hydraulic cylinder.

19. The track roller frame of claim 17 wherein actuation of the idler wheel to move along the tensioning path varies the relative vertical distance between the idler wheel and the longitudinal axis of the housing.

20. A track type machine comprising:
at least one track roller frame having a housing and a track chain;
a hydraulic cylinder mounted to the housing, the hydraulic cylinder having a piston rod extendable along a linear actuation path;
an idler wheel movably positioned in the housing, the idler wheel being movable along a linear tensioning path inclined relative to the linear actuation path; and
a coupling mechanism coupling the piston rod to the idler wheel wherein the movement of the piston rod along the actuation path actuates the idler wheel to move along the tensioning path for varying the tension in the track chain.
